(19) United States
(12) Patent Application Publication
(10) Pub. No.: US 2015/0330599 A1
(43) Pub. Date: Nov. 19, 2015

(54) LUMINAIRE WITH ANGLED REFLECTOR

(71) Applicants: Zhuo Wang, Middleton, MA (US); Bruce Radl, Stow, MA (US); John Luciani, Wakefield, MA (US)

(72) Inventors: Zhuo Wang, Middleton, MA (US); Bruce Radl, Stow, MA (US); John Luciani, Wakefield, MA (US)

(73) Assignee: OSRAM SYLVANIA INC., Danvers, MA (US)

(21) Appl. No.: 14/277,494

(22) Filed: May 14, 2014

(51) Int. Cl. F21V 7/04; F21K 99/00; F21V 7/00

(52) U.S. Cl. CPC F21V 7/04; F21V 7/0066; F21K 9/50; F21Y 2101/02

(57) ABSTRACT

A luminaire includes a plurality of solid state light sources arranged to emit light in respective angular distributions that are centered along a common optical axis. A reflector including one or more reflecting surfaces is arranged along a periphery of the solid state light sources. The reflector is positioned to receive light emitted at relatively high propagation angles from the solid state light sources, with respect to the optical axis, and reflects the light to have reduced propagation angles, with respect to the optical axis. The one or more reflecting surfaces have a generally flat cross-section that is angled away from the optical axis, and are arranged in a pattern around the periphery of the solid state light sources. The one or more reflecting surfaces can reflect specularly or diffusely.

### TECHNICAL FIELD

The present invention relates to lighting, and more specifically, to luminaires including solid state light sources.

### BACKGROUND

In recent years, solid state light sources have been replacing tradition light sources in many lighting applications. Compared with traditional light sources, such as incandescent lamps, solid state light sources are more efficient, produce less heat, have longer lifetimes, and function more efficiently at different temperatures. For these reasons and others, solid state light sources are more commonly being used in luminaires (i.e., light fixtures), such as those used for street lighting.

### SUMMARY

Embodiments of the present invention provide a luminaire that includes a plurality of solid state light sources arranged to emit light in respective angular distributions that are centered along a common optical axis. A reflector having one or more reflecting surfaces is arranged along a periphery of the solid state light sources. The reflector is positioned to receive light emitted at relatively high propagation angles from the solid state lightsources, with respect to the optical axis. The reflector reflects the light to have reduced propagation angles, with respect to the optical axis. The one or more reflecting surfaces have a generally flat cross-section that is angled away from the optical axis. The one or more reflecting surfaces reflect specularly or diffusely. In some embodiments, four reflecting surfaces are arranged in a square pattern around the periphery of the solid state light sources. In other configurations, a single reflecting surface is arranged circularly around the periphery of the solid state light sources.

The reflector of the luminaire boosts the relative intensity of the luminaire at propagation angles surrounding the optical axis. This boost flattens the angular output of the luminaire for relatively low propagation angles, particularly angles within about 20 or 30 degrees of the optical axis. When used in an overhead configuration, such as a street light, a luminaire having such a flattened angular output can provide a more uniform illuminance on the ground, which is desirable. The luminaire design allows for the use of a relatively large number of low-power solid state light sources, rather than relatively few high-power solid state light sources. Using many low-power solid state light sources effectively spreads out the emission area over a larger surface area at the luminaire, which helps reduce glare, and is also desirable. The luminaire, in some embodiments, uses relatively inexpensive solid state light sources without individual lenses attached thereto, reducing cost.

In an embodiment, there is provided a luminaire. The luminaire includes: a housing; a transmissive cover attachable to the housing, the transmissive cover and the housing defining a volume therebetween; a plurality of solid state light sources attached to the housing and disposed within the volume, the plurality of solid state light sources configured to emit light in respective angular distributions that are centered along a common optical axis, the optical axis extending through the transmissive cover and being generally perpendicular to the housing; and a reflector disposed within the volume around a periphery of the plurality of solid state light sources, the reflector comprising at least one reflecting surface, the at least one reflecting surface comprising a generally flat cross-section that is angled away from the optical axis and comprising a surface normal that extends toward the cover.

In a related embodiment, the reflector may include four reflecting surfaces arranged in a square pattern around the periphery of the plurality of solid state light sources. In a further related embodiment, each reflecting surface may be rectangular. In a further related embodiment, the reflecting surfaces may have respective edges that may be spaced apart away from the plurality of solid state light sources.

In another related embodiment, the reflector may include a single reflecting surface arranged circularly around the periphery of the plurality of solid state light sources. In yet another related embodiment, the cross-section of the at least one reflecting surface may have an inclination angle between fifteen degrees and forty-five degrees with respect to the optical axis. In still another related embodiment, the cross-section of the at least one reflecting surface may have an inclination angle between substantially fifteen degrees and substantially forty-five degrees with respect to the optical axis. In yet still another related embodiment, the cross-section of the at least one reflecting surface may have an inclination angle between twenty degrees and forty degrees with respect to the optical axis. In still yet another related embodiment, the cross-section of the at least one reflecting surface may have an inclination angle between twenty degrees and forty degrees with respect to the optical axis. In yet still another related embodiment, the cross-section of the at least one reflecting surface may have an inclination angle between twenty-five degrees and thirty-five degrees with respect to the optical axis.

In yet another related embodiment, the reflector may be positioned to receive light from the plurality of solid state light sources emitted between a minimum acceptance angle and ninety degrees with respect to the optical axis. In a further related embodiment, the minimum acceptance angle may be between fifty degrees and eighty degrees. In another further related embodiment, the minimum acceptance angle may be between fifty-five and seventy-five degrees. In still another further related embodiment, the minimum acceptance angle may be between sixty and seventy degrees.

In still another related embodiment, the reflector may be sized to have a reflector base separation, and a reflector lateral size that may be between twenty percent and forty percent of the reflector base separation. In yet another related embodiment, the reflector may be sized to have a reflector base separation, and a reflector lateral size that may be between twenty-five percent and thirty-five percent of the reflector base separation. In still another related embodiment, the reflector may be sized to have a reflector base separation, and a reflector lateral size that may be between twenty-eight percent and thirty-two percent of the reflector base separation.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a cross-section side view of a luminaire according to embodiments disclosed herein.

FIG. 2 is a perspective drawing, from above, of a luminaire in which a reflector has four reflecting surfaces arranged in a square pattern around a periphery according to embodiments disclosed herein.

FIG. 3 is a perspective drawing, from above, of a luminaire in which the reflector has a single reflecting surface arranged circularly around a periphery according to embodiments disclosed herein.

FIG. 4 is a cross-section side view of a reflector geometry according to embodiments disclosed herein.

FIG. 5 is a cross-section side view of another reflector geometry according to embodiments disclosed herein.

FIGS. 6A, 6B, and 6C are cross-section side view of reflector surfaces having different diffusive properties according to embodiments disclosed herein.

FIG. 7 is a bottom view of a square substrate with solid state light sources attached thereto, and having a central aperture therethrough, according to embodiments disclosed herein.

FIG. 8 is a bottom view of a square substrate with solid state light sources attached thereto, and devoid of a central aperture therethrough, according to embodiments disclosed herein.

FIG. 9 is a bottom view of a round substrate with solid state light sources attached thereto, and having a central aperture therethrough, according to embodiments disclosed herein.

FIG. 10 is a bottom view of a round substrate with solid state light sources attached thereto, and devoid of a central aperture therethrough, according to embodiments disclosed herein.

FIG. 11 is a bottom view of a substrate having solid state light sources attached thereto in a hexagonal pattern, according to embodiments disclosed herein.

FIG. 12 is a side view of an emission geometry for a solid state light source, according to embodiments disclosed herein.

FIG. 13 is a plot of relative intensity versus propagation angle for a solid state light source, according to embodiments disclosed herein.

### DETAILED DESCRIPTION

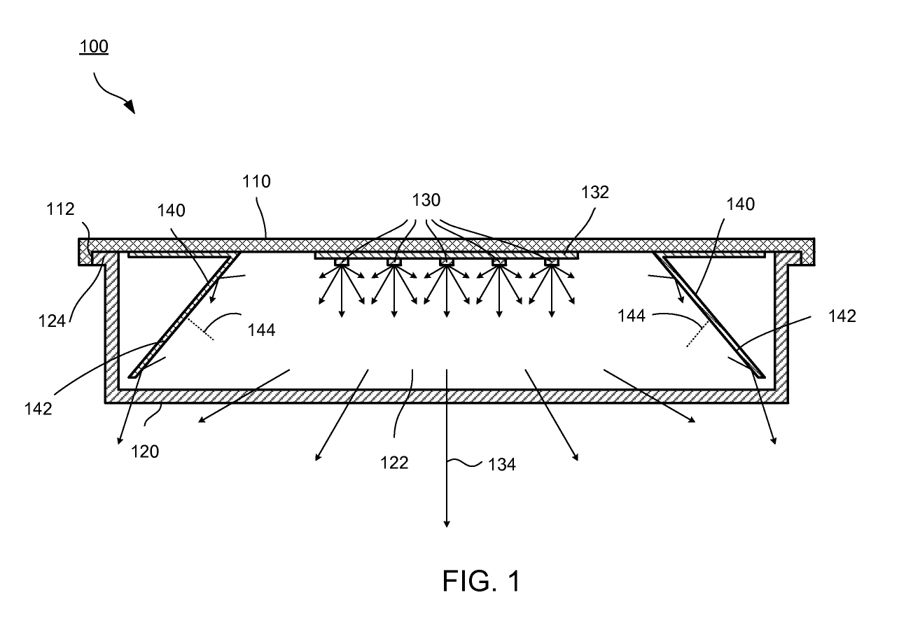

FIG. 1 is a cross-section side view of an example of a luminaire 100 configured as an overhead light source, such as a streetlight, so that the emission of the luminaire is downward. Of course, other suitable uses and orientations are also possible without departing from the scope of the invention. The luminaire 100 includes a housing 110. The housing 110 is typically formed from metal, and provides structural support for the luminaire 100. In FIG. 1 as shown, the housing 110 is generally planar, with one or more locating features 112, such as grooves or ridges, on a top or bottom of the housing 110 that are able to locate additional elements. Of course, other suitable shapes and orientations are also possible. When viewed from below, the footprint of the housing 110 may be, and in some embodiments is, square, circular, rectangular, polygonal, or any suitable shape. The housing 110 may, and in some embodiments does, optionally include one or more holes and/or openings therethrough, to accommodate wiring or other structural elements.

A transmissive cover 120 is attachable to the housing 110. In some embodiments, the transmissive cover 120 faces downward (i.e., in the same direction as at least some of the light emitted from the luminaire 100) and encloses the elements of the luminaire 100. The transmissive cover 120 and the housing 110 define a volume 122 therebetween. The transmissive cover 120 may, and in some embodiments does, include one or more locating features 124 around its perimeter, such as but not limited to a groove or ridge, that allow mating with corresponding locating features 112 on the housing 110 and locate the transmissive cover 120 with respect to the housing 110. The transmissive cover 120, in some embodiments, is purely transparent, and in some embodiments, is frosted and/or otherwise somewhat opaque, to have a diffusing effect on light transmitted therethrough, and in some embodiments is prismatic to impart changes in direction for light transmitted therethrough.

A plurality of solid state light sources 130 are attached to the housing 110 within the volume 122. The term “solid state light source” throughout refers to one or more light emitting diodes (LEDs), organic light emitting diodes (OLEDs), polymer light emitting diodes (PLEDs), organic light emitting compounds (OLECs), and other semiconductor-based light sources, including combinations thereof, whether connected in series, parallel, or combinations thereof. The plurality of solid state light sources 130 are electrically powered and mechanically supported by one or more substrates 132, which are mechanically supported by the housing 110 and are electrically connected to a suitable power supply, typically by wiring that extends through a hole in the housing 110. The plurality of solid state light sources 130 are configured to emit light in respective angular distributions that are centered along a common optical axis 134. The common optical axis 134 extends through the cover 120 and is generally perpendicular to the housing 110, to within typical manufacturing and alignment tolerances. In FIG. 1, the optical axis 134 is oriented vertically, directed downward from the luminaire 100. In other applications, the optical axis 134 is oriented as needed.

A reflector 140 is attached to, or made integral with, the housing 110 and disposed within the volume 122 around a periphery of the plurality of solid state light sources 130. The reflector 140, in some embodiments, includes one or more reflecting surfaces 142. In some embodiments, the one or more reflecting surfaces 142 have a flat and/or substantially flat cross section that is angled away from the optical axis 134. In such embodiments, one or more, or each, reflecting surface 142 has a surface normal 144 that extends toward the transmissive cover 120. In other embodiments, one or more, or each, reflecting surface 142 has a flat or curved cross section. In some embodiments, the housing 100 and the reflector 140 are both made integrally as a piece or sheet of material, such as but not limited to polyethylene terephthalate (PET).

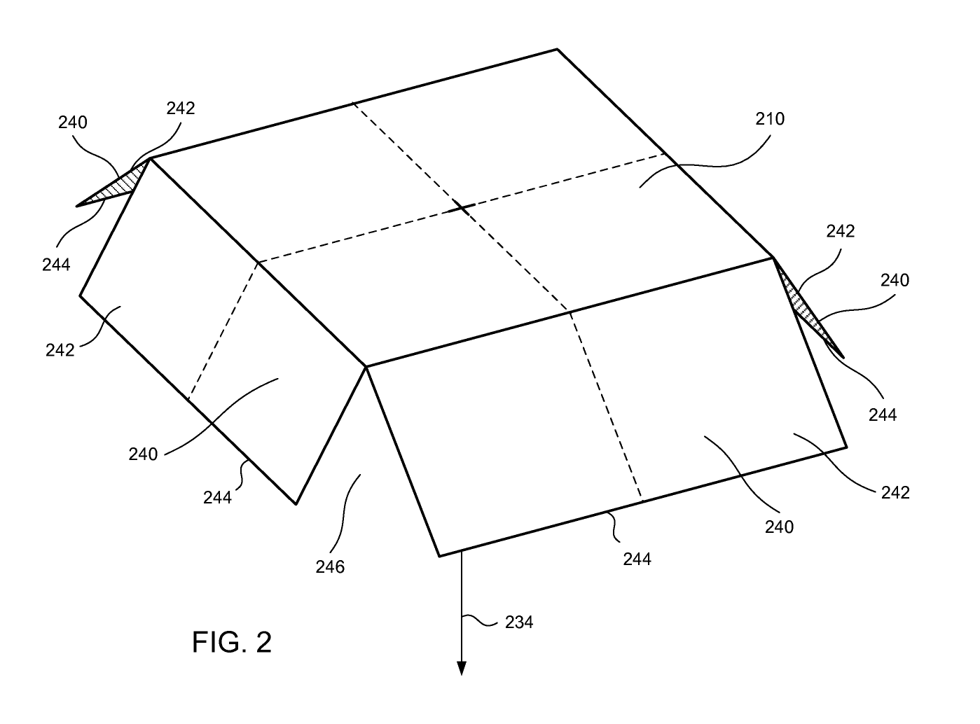

FIG. 2 is a perspective drawing, from above, of a reflector 240 including four reflecting surfaces 242 arranged in a square pattern around a periphery of solid state light sources, such as the plurality of solid state light sources 130 shown in FIG. 1 (though not shown in FIG. 2). In FIG. 2, only a portion of a housing 210 is shown for clarity; the solid state light sources are located on a face of the housing 210 that is opposite to the face shown in FIG. 2. In FIG. 2, the reflecting surfaces 242 are rectangular and are spaced apart at reflector edges 244 away from the solid state light sources. Such spacing allows light to escape through the triangle-shaped openings 246 between adjacent reflecting surfaces 242. The square pattern is but one example of polygonal geometry that embodiments use; other examples include a triangular pattern, a pentagonal pattern, a hexagonal pattern, an octagonal pattern, and so forth. In some embodiments, all the reflecting surfaces 242 in the polygonal geometry are the same in size, shape, and orientation. In other embodiments, at least one reflecting surface 242 is different in size, shape, and/or orientation from at least one other reflecting surface 242. Note than an optical axis 234 extends downward in FIG. 2.

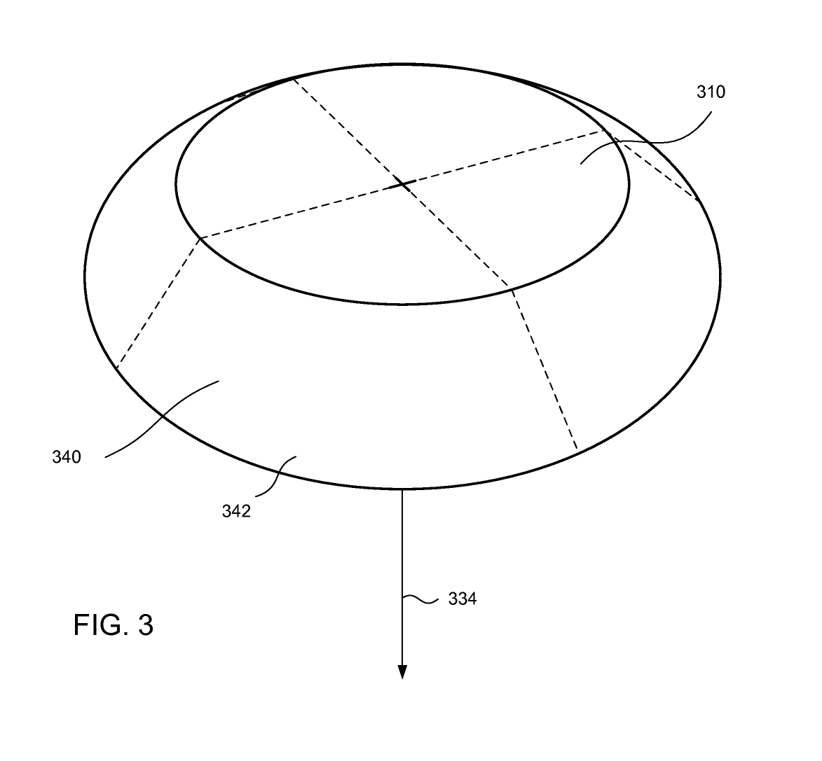

FIG. 3 is a perspective drawing, from above, of an example of a luminaire configuration in which a reflector 340 includes a single reflecting surface 342 arranged circularly around the periphery of the solid state light sources (not shown in FIG. 3 due to the orientation of the drawing). In some embodiments, such as the configuration of FIG. 3, the reflecting surface 342 is generally curved, and at an end, has a circular shape. In other embodiments, the reflecting surface 342 is elongated along a particular direction or along two or more different directions. In FIG. 3, only a portion 310 of the housing is shown for clarity. An optical axis 334 extends downward in the configuration of FIG. 3.

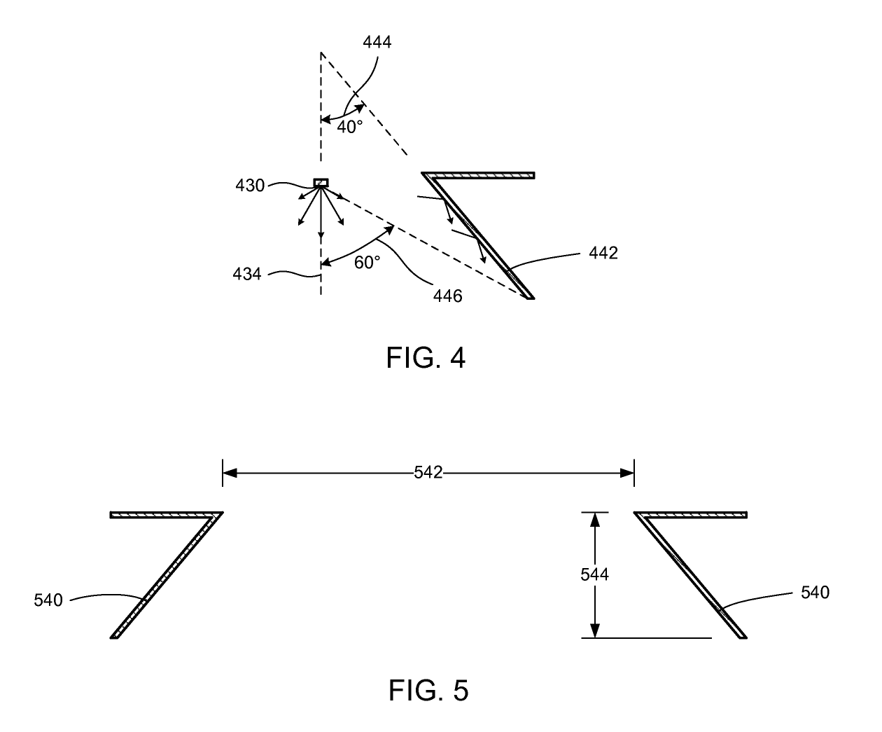

FIG. 4 is a cross-section side view of an example of reflector geometry, with respect to one or more solid state light sources. FIG. 4 shows only a right-hand cross-section; a left-hand cross-section would show similar geometry, but as a left-right mirror image. The cross-section of a reflecting surface 442 is inclined with respect to an optical axis 434 of the luminaire. The cross-section of the reflecting surface 442 forms an acute inclination angle 444 with respect to the optical axis 434, and is oriented so that light from one or more solid state light sources 430 reflects off the reflecting surface 442 and is directed toward the cover (not shown in FIG. 4; generally downward in FIG. 4). The acute inclination angle 444, with respect to the optical axis 434, in some embodiments, is between 15 and 45 degrees, and in some embodiments, is between 20 and 40 degrees, and in some embodiments, is between 25 and 35 degrees. Of course, other ranges of angles are possible. In some embodiments, the acute inclination angle 444 is the same for each reflecting surface 442 in the reflector. In other embodiments, the acute inclination angles 444 are different for at least two reflecting surfaces 442. For embodiments that include a single reflecting surface 442 having a particular shape (e.g., circular), the acute inclination angle 444 is uniform around the entire outer edge (i.e., circumference) of the reflecting surface 442, or varies.

The reflecting surface 442 in FIG. 4 is positioned to receive light from the one or more solid state light sources 430 emitted between a minimum acceptance angle 446 and 90 degrees, with respect to the optical axis 434. In some embodiments, the minimum acceptance angles 446, with respect to the optical axis 434, are between 50 and 80 degrees, and in some embodiments, are between 55 and 75 degrees, and in some embodiments, are between 60 and 70 degrees. Of course, other suitable ranges are possible. As a specific numerical example, if the minimum acceptance angle is 60 degrees, then the reflecting surface 442 receives light emitted from the one or more solid state light sources 430 with propagation angles between 60 and 90 degrees, and redirects the received light toward the cover, and, ultimately, out of the luminaire. The redirected light has propagation angles that are reduced from the range of 60 to 90 degrees to a range closer to the optical axis 434.

FIG. 5 is a cross-section side view of another example of reflector geometry. A reflector 540 is sized or positioned to have a reflector base separation 542. The reflector 540 is sized to have a lateral size between, for example, in some embodiments, 20% and 40% of the reflector base separation 542, in some embodiments, between 25% and 35% of the reflector base separation 542, in some embodiments, between 28% and 32% of the reflector base separation, or within other suitable ranges.

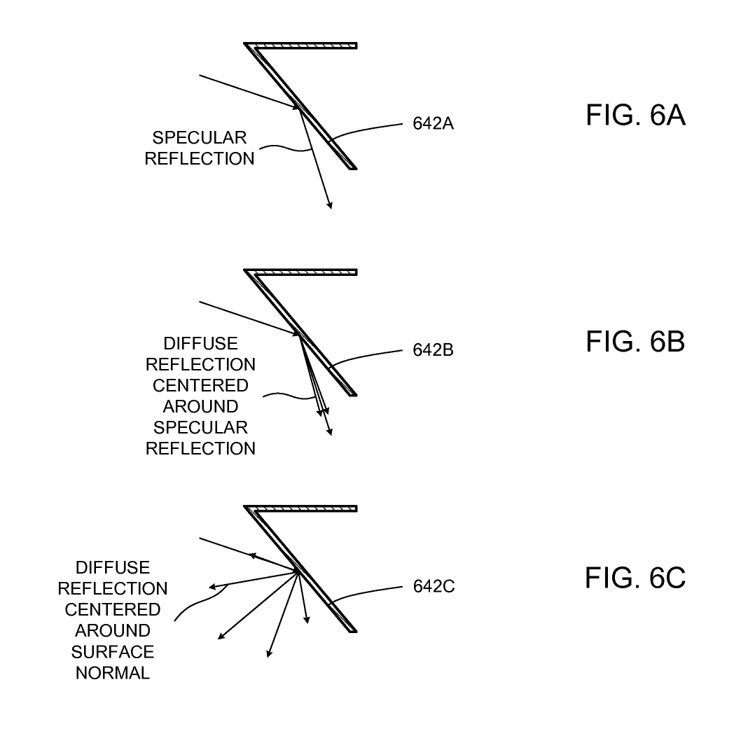

FIGS. 6A, 6B, and 6C are cross-section side views of reflecting surfaces having different diffusive properties. A reflecting surface 642A has a smooth surface and has no diffusive properties, so that light from one or more solid state light sources reflects specularly from the reflecting surface 642A. A reflecting surface 642B has a relatively small amount of surface roughness, so that light from one or more solid state light sources reflects diffusely from the reflecting surface 642B, and the diffuse reflection is centered around an angular location of a specular reflection. A reflecting surface 642C has a relatively large amount of surface roughness, so that so that light from one or more solid state light sources reflects diffusely from the reflecting surface 642C, and the diffuse reflection is centered around a surface normal to the reflecting surface 642C. In some embodiments, each reflecting surface in the luminaire has the same amount of diffusivity. In other embodiments, at least two reflecting surfaces in the luminaire have different amounts of diffusivity.

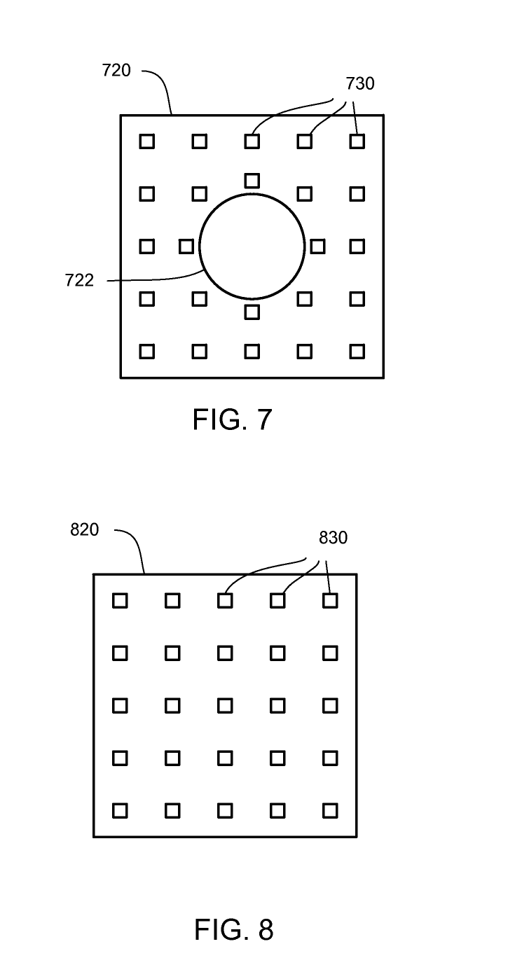

FIG. 7 is a bottom view of a square substrate 720 with a plurality of solid state light sources 730 attached thereto, and having a central aperture 722 therethrough. In FIG. 7, the plurality of solid state light sources 730 are arranged in a generally square pattern on the square substrate 720. In order to accommodate the central aperture 722, one or more solid state light sources in the plurality of solid state light sources 730 located towards the center of the pattern are omitted, and one or more solid state light sources in the plurality of solid state light sources 730 directly adjacent to the central aperture 722 are moved radially outward from the central aperture 722. Other suitable substrate sizes, shapes, and/or configurations are also possible.

FIG. 8 is a bottom view of a square substrate 820 with a plurality of solid state light sources 830 attached thereto, and devoid of a central aperture therethrough. In FIG. 8, the plurality of solid state light sources 830 are also arranged in a generally square pattern on the square substrate 820, but all of the solid state light sources in the plurality of solid state light sources 830 in the pattern are present.

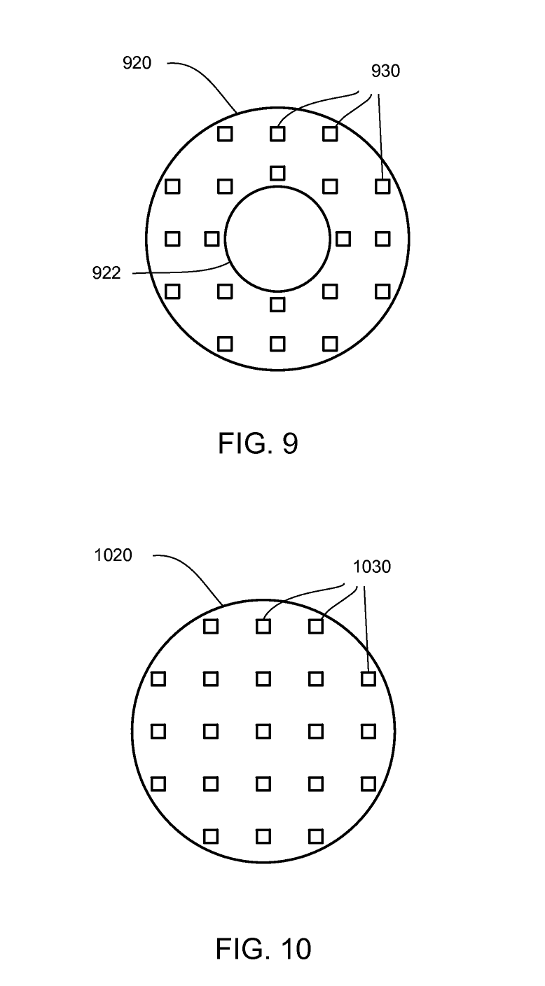

FIG. 9 is a bottom view of a round substrate 920 with a plurality of solid state light sources 930 attached thereto, and having a central aperture 922 therethrough. In FIG. 9, the plurality of solid state light sources 930 are arranged in a generally square pattern on the round substrate 920. In order to accommodate the central aperture 922, one or more solid state light sources in the plurality of solid state light sources 930 located near the center of the pattern are omitted, and one or more solid state light sources in the plurality of solid state light sources 930 directly adjacent to the central aperture 922 are moved radially outward from the grid locations. Other substrate sizes, shapes, and/or configurations are possible.

FIG. 10 is a bottom view of a round substrate 1020 with a plurality of solid state light sources 1030 attached thereto, and devoid of a central aperture therethrough. In FIG. 10, the plurality of solid state light sources 1030 are also arranged in a generally square pattern on the round substrate 1020, with all of the solid state light sources in the plurality of solid state light sources 930 in the pattern present. For solid state light sources in the plurality of solid state light sources 930 arranged in a square pattern having n solid state light sources on a side, there are up to n² solid state light sources in the pattern.

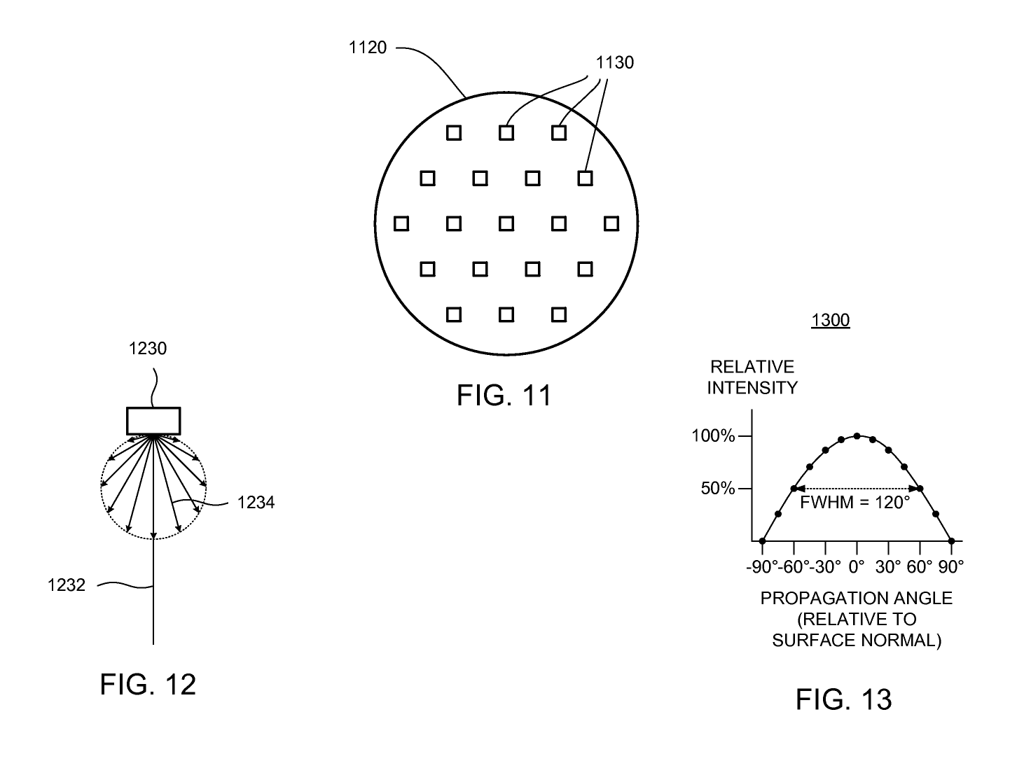

FIG. 11 is a bottom view of a substrate 1120 having a plurality of solid state light sources 1130 attached thereto in a hexagonal pattern. In some embodiments, the hexagonal pattern is preferable over a square pattern, for non-square substrate shapes. For a hexagonal pattern in which the plurality of solid state light sources 930 are arranged into, for example, concentric hexagon rings, a pattern with n rings includes solid state light sources numbering 1+3n(n+1) if a solid state light source is present at the center of the pattern, or 3(n+1)² if no solid state light source is present at the center of the pattern. For hexagonally-positioned solid state light sources, the reflector may be hexagonal. Other suitable patterns for positioning the solid state light sources are also possible, and in some embodiments, are used.

FIG. 12 is a side view of an example of emission geometry from a solid state light source 1230. For a typical solid state light source 1230, an angular emission pattern 1234 is centered around a surface normal 1232. The angular emission pattern 1234 peaks at an angle parallel to the surface normal 1232, and decreases at angles away from the surface normal 1232. The angular emission pattern 1234 drops to zero at angles perpendicular to the surface normal 1232, i.e., parallel to the emission facet of the solid state light source 1230. The angular emission pattern 1234 is characterized by the physical quantity of relative intensity, shown in FIG. 13. FIG. 13 is a plot of relative intensity versus propagation angle for a solid state light source. The relative intensity peaks at propagation angles of 0 degrees, i.e., parallel to the surface normal of the solid state light source emission facet. The relative intensity decreases from the peak value at increasing propagation angles, and drops to zero at propagation angles of 90 degrees. For solid state light sources in which the emission facet is unlensed, the solid state light source(s) have a Lambertian emission profile, in which the relative intensity varies as the cosine of the propagation angle, and the full-width-at-half-maximum (FWHM) of the relative intensity is 120 degrees. For solid state light sources in which a lens is disposed adjacent to the emission facet, the lens can increase or decrease the width of the relative intensity curve, so that the FWHM is greater than or less than 120 degrees. Many low-cost and/or low-power solid state light sources have the same angular emission pattern, with a FWHM of around 120 degrees. Advantageously, luminaire embodiments presented herein accommodate many of these low-power solid state light sources, so that parts from any suitable supplier are able to be used in the luminaire, without modification to the other luminaire elements.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or an and/or the to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A luminaire, comprising:
a housing;
a transmissive cover attachable to the housing, the transmissive cover and the housing defining a volume therebetween;
a plurality of solid state light sources attached to the housing and disposed within the volume, the plurality of solid state light sources configured to emit light in respective angular distributions that are centered along a common optical axis, the optical axis extending through the transmissive cover and being generally perpendicular to the housing; and
a reflector disposed within the volume around a periphery of the plurality of solid state light sources, the reflector comprising at least one reflecting surface, the at least one reflecting surface comprising a generally flat cross-section that is angled away from the optical axis and comprising a surface normal that extends toward the cover.

2. The luminaire of claim 1, wherein the reflector comprises four reflecting surfaces arranged in a square pattern around the periphery of the plurality of solid state light sources.

3. The luminaire of claim 2, wherein each reflecting surface is rectangular.

4. The luminaire of claim 3, wherein the reflecting surfaces have respective edges that are spaced apart away from the plurality of solid state light sources.

5. The luminaire of claim 1, wherein the reflector comprises a single reflecting surface arranged circularly around the periphery of the plurality of solid state light sources.

6. The luminaire of claim 1, wherein the cross-section of the at least one reflecting surface has an inclination angle between fifteen degrees and forty-five degrees with respect to the optical axis.

7. The luminaire of claim 1, wherein the cross-section of the at least one reflecting surface has an inclination angle between substantially fifteen degrees and substantially forty-five degrees with respect to the optical axis.

8. The luminaire of claim 1, wherein the cross-section of the at least one reflecting surface has an inclination angle between twenty degrees and forty degrees with respect to the optical axis.

9. The luminaire of claim 1, wherein the cross-section of the at least one reflecting surface has an inclination angle between twenty degrees and forty degrees with respect to the optical axis.

10. The luminaire of claim 1, wherein the cross-section of the at least one reflecting surface has an inclination angle between twenty-five degrees and thirty-five degrees with respect to the optical axis.

11. The luminaire of claim 1, wherein the reflector is positioned to receive light from the plurality of solid state light sources emitted between a minimum acceptance angle and ninety degrees with respect to the optical axis.

12. The luminaire of claim 11, wherein the minimum acceptance angle is between fifty degrees and eighty degrees.

13. The luminaire of claim 11, wherein the minimum acceptance angle is between fifty-five and seventy-five degrees.

14. The luminaire of claim 11, wherein the minimum acceptance angle is between sixty and seventy degrees.

15. The luminaire of claim 1, wherein the reflector is sized to have a reflector base separation, and a reflector lateral size that is between twenty percent and forty percent of the reflector base separation.

16. The luminaire of claim 1, wherein the reflector is sized to have a reflector base separation, and a reflector lateral size that is between twenty-five percent and thirty-five percent of the reflector base separation.

17. The luminaire of claim 1, wherein the reflector is sized to have a reflector base separation, and a reflector lateral size that is between twenty-eight percent and thirty-two percent of the reflector base separation.
